(19) United States
(12) Patent Application Publication
(10) Pub. No.: US 2007/0264985 A1
(43) Pub. Date: Nov. 15, 2007

(54) METHOD AND SYSTEM FOR RAPID CREATION OF APPLICATIONS IN COMMUNICATION DEVICES

(75) Inventors: Sanjiv KAPUR, Gurgaon (IN); Vishal KATYAL, Gurgaon (IN)

Correspondence Address: WORKMAN NYDEGGER, 60 EAST SOUTH TEMPLE, 1000 EAGLE GATE TOWER, SALT LAKE CITY, UT, 84111, US

(73) Assignee: FLEXTRONICS SOFTWARE SYSTEMS, Gurgaon (IN)

(21) Appl. No.: 11/736,085

(22) Filed: Apr. 17, 2007

(30) Foreign Application Priority Data
Apr. 17, 2006 (IN) 124/DEL/2006

(51) Int. Cl. H04Q 7/38; H04Q 7/22; H04M 3/42

(52) U.S. Cl. 455/414.1

(57) ABSTRACT

A method enabling rapid creation of combinational applications for deployment on handheld communication devices and/or customer premises equipment (CPE), which requires abstraction of platform, network and user interface capabilities for a plurality of handheld communication device and/or CPE in the form of AIBs and thereby devising steps that enables creation of combinational applications rapidly by configuring the AIBS employing an off-line environment, thus enabling rapid creation of combinational applications for deployment on handheld communication devices and/or customer premises equipment (CPE) independent of underlying networks and platforms of the same.

### BACKGROUND OF THE INVENTION

1. Field of the Invention

The present invention, in general, relates to the field of telecommunications. More particularly, the present invention provides a method enabling rapid creation of combinational applications for deployment on hand-held communication devices and/or customer premises equipment independent of underlying networks and platforms of the same.

2. Description of the Related Art

Mobile communication systems have become one of the booming areas in the field of telecommunications and it is predicted that within the next decade, a considerable number of connections will become partially or completely wireless. Rapid development of the Internet with its new services and applications has created fresh challenges for the further development of mobile communication systems.

The mobile telecommunication world is expanding laterally and vertically with the emergence of new wireless and broadband technologies and ever-growing capabilities. Wireless service providers and device makers are constantly seeking to create value added services capable of generating new revenue. Services are in part determined by software and hardware technological capability. The gradual integration into wireless devices of multiple technologies including computing, broadband, still and moving digital instruments, short-range local networking such as Wi-Fi and blue-tooth and others enable new classes of services. The convergence of all different wireless, broadband and fixed line technologies is leading to rapidly expanding world of new innovative applications. The wireless world consists of GSM, GPRS, UMTS, CDMA2000/EVDO, Wi-Fi, and UMA in addition to a diversity of broadband wireless and fixed line technologies. All these diverse wireless technologies are being further bound together with services infrastructure architecture called IP multimedia subsystem (IMS). This opens up the new era of integrated applications using various terminal and network capabilities, which needs to keep pace with ever growing network capabilities. It becomes more challenging when there is a huge variety of devices and platforms that are growing at a rapid pace. The wire-line access network includes Digital Subscriber Line (DSL), cable modem, Integrated Services Digital Network (ISDN) etc.

The new advanced wireless technology and network capabilities will be useful only if there is a simple mechanism to develop applications rapidly. There are numerous challenges in developing applications for the mobile devices and handsets that prevent rapid development and acceptance of innovative applications.

The client handheld communication devices come in wide range of platforms and operating environment from proprietary to standards based. The development and deployment of client services on numerous different mobile device platforms act as deterrent to develop new innovative applications quickly.

There are numerous communication access technologies like GSM, GPRS, UMTS, Wi-Fi, broadband etc. The applications have to be written for each technology separately, though the application flow might be quite similar. This prevents wide acceptance and re-use of services across various technologies. Hence it is difficult to implement applications that can interact with different underlying communication technologies to present unified service behaviors to the user. Application designers should not be forced to re-invent the basic mechanisms. Indeed in crossing the chasm from interesting technology to market growth, the roles of the service layer enablers, IMS, and associated service creation environments (programming environments) are just as important or maybe more as the radio technology itself. The terminal side is growing steadily in importance, which requires careful attention to the timely introduction of terminal components to provide a service. Thus, there is a need for a simple mechanism to develop applications rapidly for enabling efficient use of new advanced wireless technology and network capabilities.

The present invention addresses the aforesaid prior art problems and provides a method that enables rapid creation of combinational applications for deployment on hand-held communication devices and/or customer premises equipment independent of the operating environment and underlying communication technology.

3. Prior Art

U.S. Pat. No. 6,892,228 to Penders discloses an online service creation platform, which allows an end user of device using a platform to create applications for delivering service to mobile device. This allows the user of a mobile device to create a service for mobile device without intervention from the owner of the platform, thereby giving service creation capability to the end user but does not disclose the deployment of applications into various networks as well as the devices using universal application logic. Further, the patent discloses a typical service creation technique. It defines generic method of creating services on a server using pre-defined building blocks for Advanced Intelligent Network (AIN) services. However, it does not target next generation mobile handset devices using multiple converging technologies of GSM, UMTS, VoIP and does not identify such building blocks. Whereas the present invention identifies and defines building blocks for defining advanced services for mobile handsets.

United States Application No. 2005/0097071 to Van Gilder, James H. discloses a design of a service graph using a plurality of service independent building blocks in a graphical user interface (GUI). The patent application majorly relates to the graphical user interface for generating service graphs and only talks about generic graphical presentation. It discloses a generic service creation environment and does not disclose the identification of building blocks themselves and provide any method for rapidly creating applications for wireless and converged next generation networks as disclosed in the present invention

U.S. Pat. No. 6,967,957 to Anjum, et al. discloses a call model for providing services, which are distributed across various service providers and terminal equipment. This provides an extension of Java Telephone Application Interface (JTAPI) in order to define the call model to support basic call setup and a number of extensions, mostly designed to model call centre features, multiparty conference calls, call routing etc. However it does not define how the services are created using building blocks and graphical environment and does not aim to define reusable building blocks.

U.S. Pat. No. 6,981,263 to Zhang, et al discloses a service creation environment for application server specifically for Advanced Intelligent Network/Telecommunications Information Networking Architecture (AIN/TINA) technology and defines an Application Program Interface (API). This invention does not talk about GSM/GPRA/UMTS/IMS networks and graphical environment; further this does not address the application development for various handsets and mobile communication environment.

U.S. Pat. No. 7,117,447 to Cobb, et al. discloses a self-service call plan application development for controlling call flow logic, which is a particular specific usage. The patent talks about self-provisioning and configuration of already existing specific service i.e. toll free. However, the patent does not talk about graphical tool based development of toll free, it assumes that toll free application already exits. It allows customers to self-provision the flow of the toll free application using graphical interface. Further, the invention is for a particular technology (Intelligent network) meant for network nodes and PSTN (not wireless). Also, the pre-defined feature set supported by the application is for a particular functionality that is required for realizing toll free application. Whereas the present invention pertains to rapid development of any application and not meant for some specific application customization. The present invention identifies all the different blocks and different variety of service functions that can be combined to create any new application and not just customize an existing application. Hence, the applicability and usage thereof is totally different. Also, the present invention is for next generation wireless networks (independent of technology whether GSM, GPRS, UMTS, WiMAX, UMA etc) and is meant for application development for handheld devices or customer premises equipment.

The abovementioned prior arts disclose different service creation environments and techniques for customization of existing services. However, none of the prior arts either alone or in combination thereof, suggest the method enabling rapid creation of combinational applications for deployment on hand-held communication devices and/or customer premises equipment independent of underlying networks and platforms of the same and the associated system disclosed in the present invention.

### SUMMARY OF THE INVENTION

It is a principal aspect of the present invention to devise a method enabling rapid creation of combinational applications for deployment on handheld communication devices and/or customer premises equipment (CPE), which requires abstraction of platform, network and user interface capabilities for a plurality of handheld communication device and/or CPE in the form of AIBs and thereby devising steps that enables creation of combinational applications rapidly by configuring the AIBS employing an off-line environment, thus enabling rapid creation of combinational applications for deployment on handheld communication devices and/or customer premises equipment (CPE).independent of underlying networks and platforms of the same.

It is another aspect of the present invention to devise a method for rapidly creating combinational applications for deployment on handheld communication device and/or customer premises equipment (CPE) by an application developer.

In accordance with another aspect of the present invention, the present invention discloses a system for providing combinational applications to handheld communication device and/or customer premises equipment (CPE).

These and other aspects of the invention are described below in different embodiments of the invention, however the invention is not restricted to particular embodiments described hereinafter.

In accordance with a preferred embodiment of the present invention, there is provided a method enabling rapid creation of combinational applications for deployment on handheld communication device and/or customer premises equipment (CPE) by identifying a plurality of application independent blocks (AIBs) which requires abstraction of platform, network and user interface capabilities for said handheld communication device and/or CPE, realizing any one of said combinational applications employing any one of said plurality of AIBs by a Graphical User Interface (GUI), designing and linking said AIBs by said GUI to generate an application flow graph and generating any one of said combinational applications by a build environment wherein the method enables an application developer to rapidly create combinational applications in an off-line environment, said combinational application is deployed on handheld communication device and/or CPE independent of underlying networks and platforms of the same.

In accordance with another embodiment of the present invention, there is provided a method for rapidly creating combinational applications for deployment on handheld communication device and/or customer premises equipment (CPE) by an application developer by identifying an application to be created, defining a plurality of Application Independent Blocks (AIBs) specific to said application chosen, generating an application flow graph to generate platform independent application code, selecting platform specific to said handheld communication device or CPE and generating said combinational application by linking said platform independent application code to said platform dependent modules corresponding to said selected platform employing an off-line environment.

In accordance with yet another embodiment of the present invention, there is provided a method, wherein said combinational applications are reusable for creating any of plurality of new applications.

In accordance with yet another embodiment of the present invention, there is provided a method, wherein the AIBs are service functions for creating combinational applications.

In accordance with yet another embodiment of the present invention, there is provided a method, wherein said AIBs are pre-integrated.

In accordance with still another embodiment of the present invention, there is provided a method, wherein said AIBs are capable of encompassing user defined functionalities to enable reuse of said user defined functionality.

In accordance with another embodiment of the present invention, there is provided a method wherein said application flow graph defines universal application logic.

In accordance with still another embodiment of the present invention, there is provided a method wherein said method is implemented employing IMS client technology over existing technologies.

In accordance with yet another embodiment of the present invention, there is provided a method wherein said underlying network technologies comprise existing and next generation wireless and wireline network technologies.

In accordance with yet another embodiment of the present invention, there is provided a system for providing combinational applications to handheld communication device and/or customer premise equipment (CPE). The system comprises a plurality of handheld communication device and/or CPE in communication with a network, a receiving means for receiving user preferences for application deployment which thereby causes an application developer to choose an application specific to said user preference. Further, the application developer identifies a plurality of Application Independent Blocks (AIBs) specific to said application chosen, generates an application flow graph to generate platform independent application code, selects platform specific to said handheld device or CPE which results in generation of the combinational application by linking said platform independent application code to platform dependent modules corresponding to said platform by employing an off-line environment. Thus, the system enables the application developer to rapidly create combinational applications in said off-line environment for deploying said combinational applications in said handheld communication device and/or CPE independent of underlying networks and platforms of the same.

In accordance with yet another embodiment of the present invention, there is provided a system wherein said combinational applications are reusable for creating any of plurality of new applications.

In accordance with yet another embodiment of the present invention, there is provided a system wherein said AIBs are service functions for creating combinational applications.

In accordance with yet another embodiment of the present invention, there is provided a system, wherein said AIBs are pre-integrated.

In accordance with still another embodiment of the present invention, there is provided a system, wherein said AIBs are capable of encompassing user defined functionalities to enable reuse of said user defined functionality.

In accordance with still another embodiment of the present invention, there is provided a system wherein said application flow graph defines universal application logic;

In accordance with yet another embodiment of the present invention, there is provided a system wherein said method is implemented employing IMS client technology over existing technologies.

In accordance with still another embodiment of the present invention, there is provided a system wherein said underlying network technologies comprise existing and next generation wireless and wireline network technologies.

Our invention thus identifies application/service blocks that can be used to create innovative combinational services for existing and next generation services.

### BRIEF DESCRIPTION OF THE DRAWINGS

Further aspect of the present invention together with additional features contributing thereto and advantages accruing therefrom will be apparent from the description of preferred embodiments of the present invention which are shown in the accompanying drawing figures.

FIG. 1 illustrates a system for providing combinational applications to handheld communication devices and/or customer premise equipment (CPE) in accordance with the present invention

FIG. 2 is a flow diagram, which describes the process involved in rapidly creating combinational applications for deployment on a handheld communication device and/or CPE.

FIG. 3 is an example process flow of a simple call flow of an application created using AIBs for an active answering machine according to the teachings of the present invention.

FIG. 4 is an alternative example process flow for call flow of an application created using AIBs for an active answering machine in accordance to the teachings of the present invention.

### DETAILED DESCRIPTION OF THE INVENTION

The present invention provides a method for rapidly creating new and innovative combinational services in a graphical way, customization and deployment of services on the mobile devices by the application developer irrespective of the device platform and operating environment and the underlying communication technology.

The ability to combine multiple service capabilities to build a new innovative user application is what is referred to as combinational service. The combinational service should be able to simultaneously use the multiple capabilities such as, multiple network access capabilities, multiple platform capabilities, multiple service capabilities and multiple user-interface capabilities. The multiple network access capabilities include circuit switched voice call, packet data based MMS, data access etc., multiple platform capabilities such as phonebook, calculator, browser, device management SIM access, security, camera, speaker etc. The multiple platform capabilities also include operating system utilities such as MAT library, string library and other utilities in a single application i.e. utilities which are generic in nature which provide standard functionalities such as operation and string operations and other common mechanisms The multiple service capabilities include Push to talk, SMS, MMS, presence, video telephony, voice telephony etc, and the multiple user interface capabilities such as dialog, view, query box, pop up, list down etc

The present invention defines the “mechanism/approach/method to create applications and identified re-usable components—Application independent Building Blocks (AIBs) to create applications for the converged wireless/VoIP/WiFi/Fixed Line network” with the least of effort and time. The present invention also provides a graphical mechanism to link the AIBs to quickly create, test and deploy value added services for the whole range of diverse handset devices for the next generation wireless and converged networks. The invention also identifies the AIBs to create such advanced applications for the existing and evolving communication technologies.

The Application development platform shall provide mechanism to convert any of the developed application into AIB itself This AIB can then be used as building block for creating multiple applications. e.g. Push to talk, messaging, video sharing and voice call AIBs can be combined to build Quizzing application. This quiz application can be added as an user defined AIB by the application developer. This quiz AIB can then be used to define and create multiple applications such as Tambola, Examination application etc. This is an advanced usage of making innovative combinational services and the flexibility achieved in developing applications for handsets.

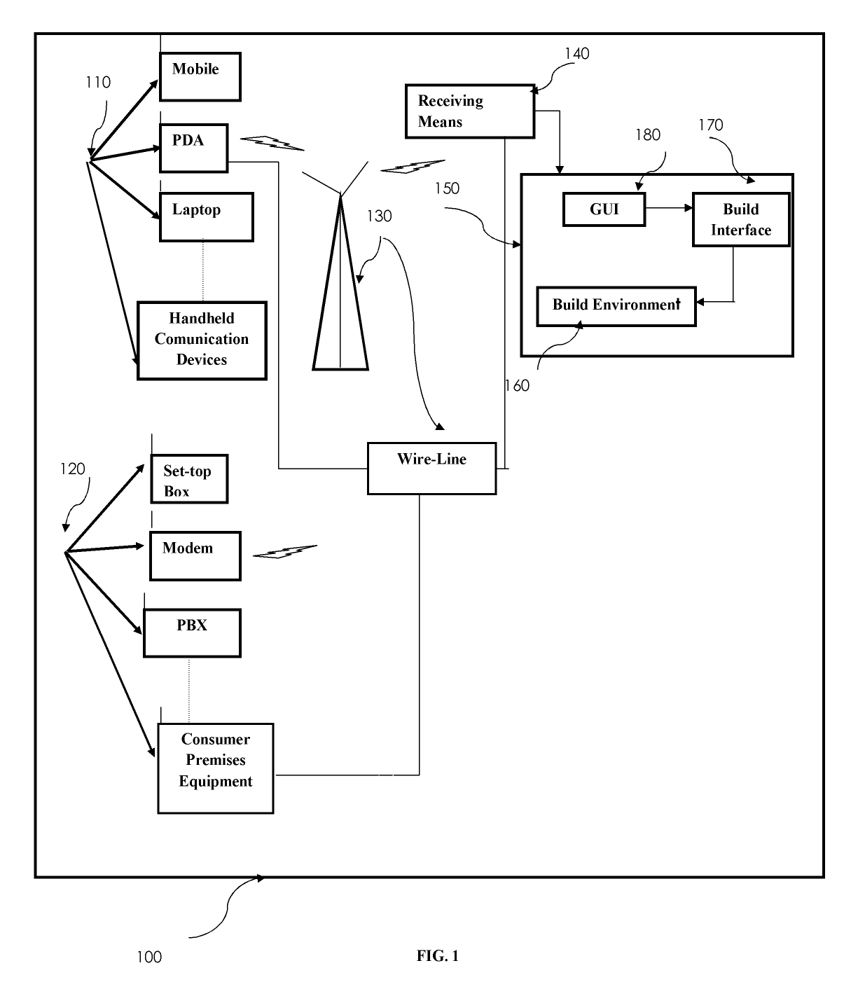

FIG. 1 illustrates a system (100) that provides combinational applications for deployment in handheld communication devices (110) and/or CPE (120). The system comprises a plurality of handheld communication device (110) and/or customer premises equipment (120), a receiving means (140) for receiving user preference for application deployment, wherein the receiving means is any device capable of receiving request from a plurality of sources, and an off-line tool/environment (150) wherein the handheld communication devices (110) and CPE (120) are in communication with a network (130), which is further in communication with a receiving means (140) and the offline tool (150). The handheld devices (110) may be a cell phone, laptop, PDA etc. The customer premises equipment (120) may be a set-top box, modem, PBX etc. The offline tool/environment (150) comprises a Graphical User Interface (GUI) (180), a build interface (170) and a build environment (160). Further, the application developer may receive a request from a service provider who intends to introduce a new service into the network, a device manufacturer who intends to introduce a new application or a request is received to develop application using the existing network infrastructure.

The GUI (180) comprises menu bar, tool bar, AIB palette, canvas, AIB tree view area and build result area. Menu bar is a horizontal bar at the top of a window, below the title bar containing drop down menu. The various drop down menu optionally allow the application developer to perform various tasks including opening new or existing application graphs, specifying application build options, compiling and building the applications, etc. Tool bar contains icons for performing some of more common tasks, so that the application developer does not have to remember the menus for the same. AIB palette contains various pre-integrated as well as user-defined AIB Groups. The AIB groups contain AIBs having similar functionalities. These groups may further be divided into sub-groups. AIBs are the basic building blocks of an application. Each AIB has a specific functionality associated with it. These AIBs can be chained together in a graph to define the application logic. Every AIB has a set of input/output parameters and connection events that define its behavior during application execution. A large number of AIBs come pre-integrated with an offline tool/environment (150). There are a large number of AIBs preintegrated with an offline tool (150) which includes application specific AIBs, general IMS functionality, GUI blocks, and general purpose AIBs. These various AIBs are further explained in detail hereinafter. Further, the AIBS are also capable of encompassing user defined functionalities to enable reuse of said user defined functionality. Any new user defined function can be made available in the form of new user defined AIB by importing the required function in the GUI of the off-line tool, wherein importing refers to integrating or configuring a user-defined source code which offers some functionalities or logic that can be reused across various applications. It involves following guidelines to implement user interface and configuring within the off-line tool to make it available for future use.

For example: The application Specific AIBs includes Push to Talk over Cellular (POC), presence, Giga Link Module (GLM) and Global System for Mobile Communication (GSM) call handling. POC provides open mobile alliance (OMA) complaint Push to Talk (PTT) functionality with support for various features which includes one to one and one to many adhoc session, group and chat sessions, group advertisement and instant personal alert, session updates, adding user to existing session and leaving/re-joining session. Presence provides OMA compliant presence functionality with support for features like publish of presence information, subscription to presence information for a person or a group, subscription to information about persons watching the presence information of a user and support for controlling the information displayed to other users, similarly GLM provides OMA complaint group and list management functionality whereas GSM call handling provides the capabilities for GSM call related functionalities to be invoked from the application.

General IMS functionality includes IMS session, IMS messaging, application add, register and de-register. The IMS session provides capabilities for establishing IMS sessions with user-defined quality of service (QOS) parameters. Various types of supported sessions included in IMS session are audio only, video only or audio/video session and send only, receive only or send/receive session. IMS messaging provides the functionality for sending text messages over IMS networks, whereas application add provides the filter criteria of the application to IMS client stack. This filter criterion is used by (ICF) to distribute network-initiated sessions. Further, registers work to register a public user identity on IMS network and de-registers does the de-registration of a previously registered public user identity on IMS network.

GUI blocks AIBs includes create view, input box, query box, phone book, timed note and popup display. Create view creates a view for the application and a menu from the user specified options. Input box gets some textual input from the user during application execution. Query box requests a yes or no response to a question from the user using a modal query dialog. Phone book displays the phone book of the device for selecting an entry from it. Timed note displays an information dialog on the screen for a specified duration with the specified lines of text. Popup display displays a modal information dialog on the screen with the specified lines of text.

General purpose AIBs includes string manipulation, date and time, mathematical functions, comparison functions and conversion functions. String manipulation performs basic string operations on arguments. The various string operations includes concatenation of two strings, copying one string to another, checking the length of a string and searching for a sub-string within a string. Date and time gets the local date and time. The mathematical function performs mathematical operations on the provided arguments supported by addition, subtraction, division, multiplication, modulus, absolute, logarithm and power. Comparison function compares the arguments, various comparison functions includes compare numeric values, strings, times of day, days of year, days of week etc. Further the conversion function converts from one data format to another. The conversion supported are string to numeric, numeric to string, string to date and date to string.

While the input/output parameters and connections are exposed to the application designer for specifying the behavior of the AIB, the actual implementation of these AIBs are hidden.

Multimedia session AIBs include GSM/CDMA voice session AIB, UMTS/CDMA2000 multimedia session AIB, IMS multimedia session AIB, SIP multimedia session AIB. The functionality of Multimedia session AIBs include initiating and creating an outgoing audio and video session, handling of incoming audio or video session indication, addition or deletion of multimedia streams in an existing session i.e. adding a video stream to an existing audio session or dropping of video stream from an existing audio and video session, manipulation/control of various session legs. The IMS session AIB provides audio/video/audio video session. IMS session AIB will allow user voice and video communications shared with a single recipient.

Data session AIBs include GPRS session AIB and wi-fi session AIB. These AIBs are used for connection management for setting up and releasing a data session and to send and receive data.

Content sharing and management AIBs allows users and operators to set up their own storage area where they can post pictures, music and other multimedia content to share with others.

Service feature AIBs provides capabilities for building value added services featuring in the application and includes feature interaction AIB, IMS presence AIB, IMS push to talk AIB, session waiting AIB, multi party conferencing AIB, session on hold AIB, session forwarding AIB, session transfer AIB and policy control AIB. The feature interaction AIB defines system behavior including interaction between various service features or applications e.g. behaviors of service, whether it needs to be suspended or revoked, when another service is invoked by the user, and includes compound behaviors of diverse services offered by GSM, GPRS, IMS, UMA, wifi etc. IMS presence AIB providing the presence capability of presence source (publish presence information), watcher (subscribe for and receive notifications for presence information), RLS client (group subscriptions), presence XDM client (manage presence policies) and watcher information subscriber (subscribes to dynamically changing set of presence watchers). It provides presence functionality of subscribe/notify and xml parsing capability independent of underlying technology which could be IMS or SIP. IMS push to talk AIB provides push to talk service features to build advanced applications like POC session initiation, handling of incoming and outgoing POC session, floor control management. This AIB can be used for developing applications, which use POC as the underlying infrastructure such as gaming or quiz applications. Session waiting AIB is used for putting the existing session on hold when another instance of the session if invoked and the associated resources are re-allocated. Multi-party conferencing AIB provides the capability for multiparty conferencing. Session on hold AIB provides the capability for the user to put an existing session on hold without releasing the session. Session forwarding AIB provides the capability to the user to forward incoming sessions to another device. Session transfer AIB provides capability to the user to transfer incoming sessions to another device when in call. Policy control AIB provides black & white listing of other contacts/users for accessibility and published information which allows GSM calls, POC sessions, VOIP & video sessions, video sharing, email, MMS, SMS, instant sharing, conferencing etc. The policy control can be time based, priority based, terminal capability based and network accessibility based.

(OTA) device management AIB represents the OMA specification based device management capability on hand held devices used for data synchronization and device management. It provides the capability to specify set of commands to be executed on server and retrieving responses received for commands requested.

Group & list management AIB represents the capability for group management. It provides the features i.e. Group creation, modification, deletion and subscription to other group information. This work is carried over XCAP protocol.

Data manager AIB provides functionality for managing data, which includes store data, retrieve data, define schema, modify schema, delete schema, add record, modify record and delete record.

Licensing AIB controls the licensing of features for development of AIBs following the standard interface such as COM components/java beans/XML etc. so that these can be easily developed and plugged into various application environments.

The GUI (180) includes a canvas area where an application developer can design new graphs or open/modify existing application graphs. Multiple graphs can be opened at once in the canvas, but only one graph will be the active graph, i.e. will have focus at any given time. Further an AIB tree view area is used to show the AIBs used in the application graph(s). It can be used to highlight a particular AIB in a complex graph. The AIB tree view area shows all the application graphs that are currently open. The view for a particular graph can be collapsed or expanded as and when needed. Build result area which is further a part of GUI (180) is used to display the results of graph compiled and the build results of an application. Further, any errors/warnings are displayed in this area.

Build interface (170) provides the link between the GUI (180) which further helps application developer to define the application logic by chaining the AIBs in a graph. Build environment (160) generate the applications based on this graph. The Build Interface (170) captures the information from the graph, saves this information in an xml-like format, passes on this information to the code generator which is a part of build environment, and passes application build parameters like build platform (Symbian/Windows mobile), build type (release or debug), etc. to code generator. The information captured from the graph includes application graph properties (global properties that have been defined for the graph like any user libraries to be included during application generation), list of AIBs (All the AIBs that have been used in the application graph), parameters (Input/output parameters of each AIB and also those parameters which have been populated and what are their values) and connections (the connection list of each AIB, the connections that have been used in the application graph, and which AIBs are the connections linking).

The build environment (160) uses the information obtained from the build interface (170) for generating the final application. While GUI (180) provides a framework for user interaction wherein the application developer can define the application further, the build environment (160) does the actual application generation. The build environment (160) comprises code generator, libraries and compile and link modules. The code generator takes the inputs from the build interface (170), and generates the files for final application. The generated files include: C++ source files for application functionality, corresponding header files, platform specific application initialization files, platform specific resource files and platform specific project files (e.g. .mmp and .pkg files for symbian, and .vcproj file for Windows Mobile). The build environment (160) further comprises system libraries and user libraries. The system libraries are the libraries that come as part of the platform Software Development Kit (SDK) and are needed for performing some platform specific functionalities like performing GUI specific tasks, Inter Process Communication (IPC), etc. The user libraries contain pre-compiled code for the AIBs that are used in the application graph. Compiler compiles the code generated by code generator and links the various libraries as needed, and generates the final application that is ready to be deployed on the handheld device (110) and/or CPE (120).

The capabilities which have to combined to create the offline tool for integrated application development are: set of pre-tested and pre-integrated AIBs which include IMS functionalities like PoC, Presence etc. as well as general functionalities like string and numeric operations, grouping of AIBs as per their functionalities, ability to integrate user defined data-types, AIBs and libraries, capability to define application logic by chaining AIBs in a graph and customizing them, completely user-customizable AIB behavior (input/output parameters and flow of control), ability to define control flow as well as data flow in the application graph, fully integrated build environment to generate ready to deploy applications, window for graph compilation and build results which can be viewed and used to create applications on symbian and widows mobile platforms, uniform user-interface of generated applications on various platforms, code generation in commonly used target languages like C/C++/java, platform independent architecture and wrappers for platform specific behavior, context specific icons for various AIBs, supporting intelli-sense and XML based data repository and AIB pallet, which can be used readily via easy drag and drop.

The application developer is provided with some AIBs (e.g., IMS Session, PoC, Presence, etc.) each of which has some functionality associated with it. These AIBs can be used as functional blocks to develop innovative end user applications. An application developer can drag these AIBs onto a graph area provided, chain them according to the application logic, and define their properties as desired in the application. Further an application developer can also define the properties of the application to be generated like the platform, release-type (debug or release), etc.

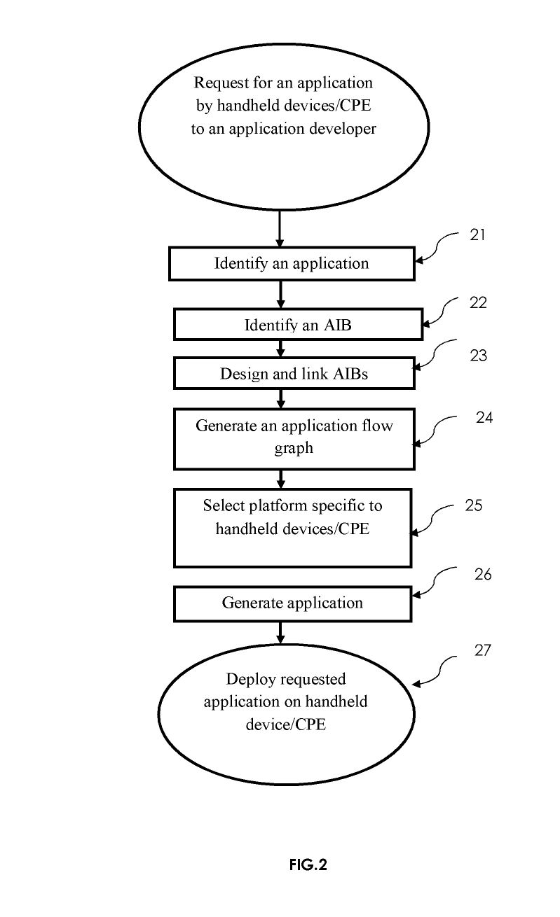

FIG. 2 provides a flow diagram of a process for rapidly creating combinational applications for deployment on a handheld communication device/CPE in accordance with an embodiment of the present invention. In this process at step (200) the user of a handheld device (110) or CPE (120) sends a request via network (130) to an application developer. The application developer identifies an application at step (210). At step (220) an application developer identifies an AIB in accordance to the requested application. Designing and linking of AIBs take place at step (230). An application flow graph at step (240) is generated within GUI (180). After the generation of application flow graph, selection of platform dependent module specific to handheld devices (110) and/or CPE (120) is carried at step (250). The final combinational application is generated at step (26) by linking the platform independent application code to said platform dependent module corresponding to selected platform employing an offline environment. The platform dependent modules are created and made available in the environment to access certain platform functions. The platform dependent modules need not be created repetitively. It is a one activity, which is performed at the time of creating the off-line environment. The final requested application by the user is deployed on handheld device (11) and/or CPE (120) at step (270).

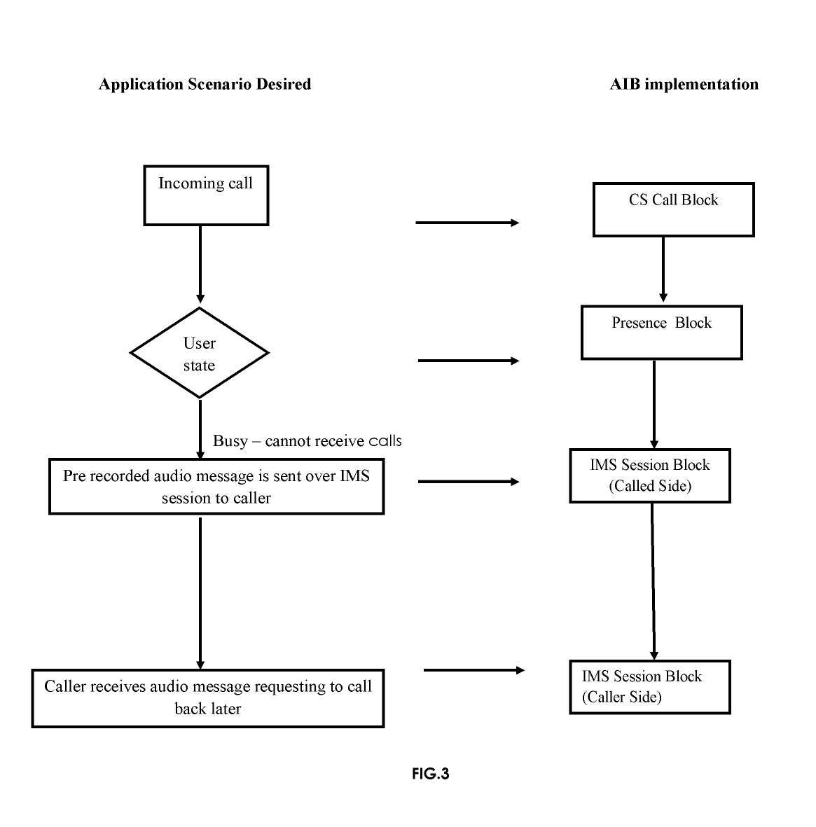

FIG. 3 is an example process flow of a simple call flow of an application created using AIBs for an active answering machine according to the teachings of the present invention. The active answering machine is a presence enabled application that targets the category of users looking for “rich communications” applications. It combines users' presence information with functionalities of messaging and voice/video over IMS to respond to incoming circuit switched calls in a highly configurable manner. When a user has an incoming circuit switched call, the system can respond to it in a variety of ways that are pre configured and which operate on the called party's presence information. The response can involve replying with a text message from a set of pre defined messages corresponding to various presence/mood states, replying with a voice message from a set of pre recorded voice messages where the audio message is pushed to caller, requesting the caller to record a voice message and then recording the caller's audio message. The message is stored in the Inbox and can be played at a later time. The inbox status (New Message waiting) is reflected to the called party. Further it involves requesting the caller to record a video message and then send it as MMS. The message is stored in the Inbox and can be played at a later time. The inbox status (New Message waiting) is reflected to the called party.

The aim is to provide time-based profiles for defining incoming session request handling, presence features as per OMA specifications and integrated IMS and GSM features. Here there are 3 entities involved in the process, which includes the called party, the calling party and the service provider. There are some entity specific issues that need to be addressed which are as follows. The called party typically has various presence states and mood states. The presence states can be of the following types i.e. driving to work, at office desk, in meeting, at lunch, driving back home, at home etc. The mood states may include happy, excited, sleepy, surprised etc. The called party wants to utilize these presence/mood states to respond to incoming calls in a specific manner. The called party will be able to configure these responses in a very easy manner and able to track any follow up actions on his/her part.

The calling party needs to get in touch with the called party and so would like to respond to the called party's presence/mood settings. He/she will be able to leave an appropriate response (for e.g. leave a voice message or video clip etc.) in an easy intuitive manner and yet ensure that the called party gets notified.

The service provider wants to attract customers to new service, reduce subscriber chum to other network providers and maximize potential for IP-services, offering new revenue generating services. The present invention enables called and calling party to prioritize their schedules and respond to calls appropriately and ensures effective communication at all times (voice/data). It also enables the service provider to have increased revenue generation and customer stickiness.

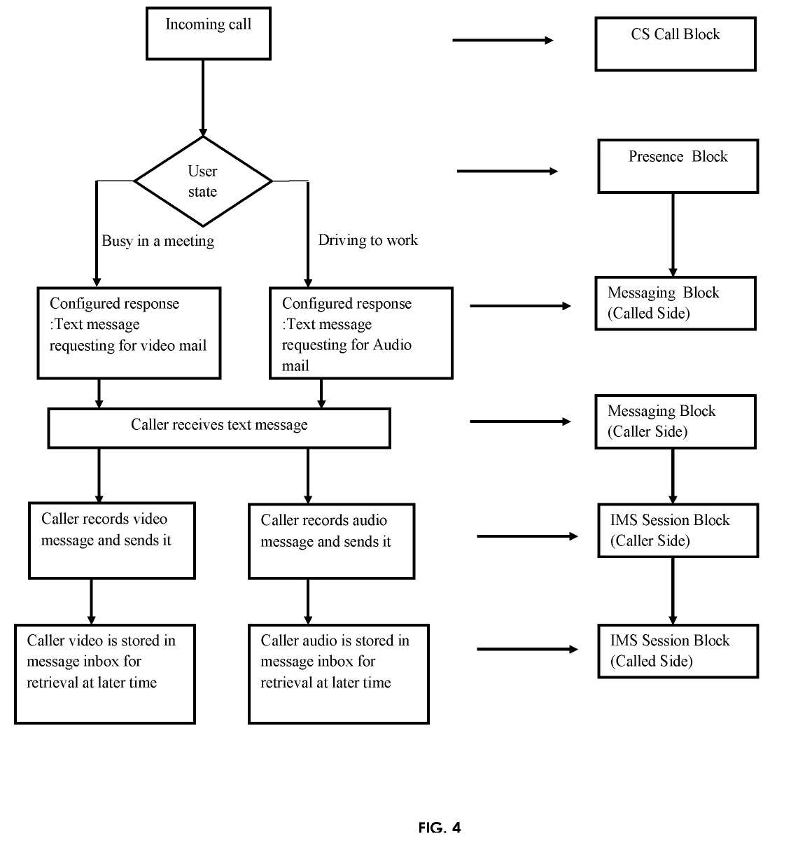

FIG. 4 illustrates an alternative example of a process for call flow of an application created using AIBs for an active answering machine in accordance to the teachings of the present invention. To create a full-fledged presence enabled active answering machine the following extensive list of AIBs are used. The blocks are dragged and dropped in the AIB palette and then connected graphically as per the requirements of the call flows. When a state diagram is complete the application is compiled to generate the final executable. The executable when loaded onto the user's handset will allow the user to utilize the services of the active answering machine for e.g. create view used for defining menu items for various user actions. The create profile AIB will be used for defining answering machine profiles. The profiles will include the information needed for responding to incoming session requests. The profile data will include profile name, time duration during which profile is active, user response while this profile is active, and data needed for user response (like message text, audio file, etc.). Form is used for getting the input data from user for creating profiles. Similarly date time is used for getting current date and time, get profile for getting the currently active profile based on current time. IMS Session employed for initiating a new session, and handling incoming sessions. It will also provide media-related capabilities, like playing an audio file, and receiving and saving an audio stream. Presence for setting and getting “presence” and “mood” states. IMS messaging for sending text messages over ICF.GSM messaging used for sending SMS and MMS over GSM network. Phone book for displaying the contacts information, Case for defining actions based on values, compare numeric for comparing “Presence” and “Mood” states, query box for getting “Yes/No” responses from user and popup display for displaying some information.

Other examples of applications which can be created using the present invention are given below. The examples are given only for illustrating the present invention and do not intend to limit the use of the present invention. These examples includes say-as-u-please, community broadcasts, enterprise alert, see-where-they-are and keep-in-sight etc. Say-as-u-please is a fun-application that allows a user to select a voice profile and apply it to his own speech to create an emoticon'ed experience. This extends emoticons from image to multimedia morphing. Community broadcasts is a way of leveraging the underlying PoC infrastructure to create community events—these events could be voice or video based and may be religious events (like Namaaz) or entertainment events (like game shows). Enterprise alert is a simple alert service using text, voice or video that can be configured to send reminders or setup sessions. See-where-they-are is a unique way of tracking your friends and family—this application integrates a 3rd party map (google maps, yahoo maps) and uses the presence and location information to show everyone on a map and keep-in-sight includes the tracking application to a single user and follow their location, moods etc.

The present invention can also enable personalization by extending control from an application developer to the service provider and the end user.

The disclosed embodiments are illustrative from various ways in which the present invention may be practiced. Other embodiments can be implemented by those skilled in the art without departing from the spirit and scope of the present invention.

### LIST OF ABBREVIATIONS

GSM: Global System for Mobile Communication

GPRS: General Packet Radio Service

UMTS: Universal mobile telecommunications system.

CDMA 2000/EVDO: Code Division Multiple Access

Wi-Fi: Wireless Fidelity

Wi MAX: Worldwide Interoperability for Microwave Access

UMA: Unlicensed Mobile Access

IMS: IP Multimedia Sub-System

AIN: Advanced Intelligent Network

TINA: Telecommunications Information Networking Architecture

VOIP: Voice over Internet Protocol

OTA: Over the Air

OMA: Open Mobile Alliance

SDK: Software development kit

IPC: Inter process communication

We claim:

1. A method enabling rapid creation of combinational applications for deployment on handheld communication devices and/or customer premises equipment (CPE), the method comprising:
identifying a plurality of Application Independent Blocks (AIBs) by abstraction of platform, network and user interface capabilities for said handheld communication device and/or CPE;
realizing any one of said combinational applications employing any one of said plurality of AIBs by a Graphical User Interface (GUI);
designing and linking said AIBs by said GUI to generate an application flow graph; and
generating any one of said combinational applications by a build environment wherein the method enables an application developer to rapidly create combinational applications in an off-line environment, said combinational application is deployed on handheld communication device and/or CPE independent of underlying networks and platforms of the same.

2. A method for rapidly creating combinational applications for deployment on handheld communication device and/or customer premises equipment (CPE) by an application developer, the method comprising:
identifying an application to be created;
defining a plurality of Application Independent Blocks (AIBs) specific to said application chosen;
generating an application flow graph to generate platform independent application code;
selecting platform specific to said handheld communication device or CPE; and
generating said combinational application by linking said platform independent application code to platform dependent modules corresponding to said selected platform employing an off-line environment.

3. The method as claimed in any of claims 1 or 2, wherein said combinational applications are reusable for creating any of plurality of new applications.

4. The method as claimed in any of claims 1 or 2, wherein said AIBs are service functions for creating combinational applications.

5. The method as claimed in any of claims 1 or 2, wherein said AIBs are pre-integrated.

6. The method as claimed in claim 1 or 2, wherein said AIBs are capable of encompassing user defined functionalities to enable reuse of said user defined functionalities.

7. The method as claimed in any of claims 1 or 2, wherein said application flow graph defines universal application logic.

8. The method as claimed in any of claims 1 or 2, wherein said method is implemented employing IMS client technology over other existing technologies.

9. The method as claimed in any of claims 1 or 2, wherein said underlying network technologies comprise existing and next generation wireless and wire-line network technologies.

10. A system (100) for providing combinational applications to handheld communication devices (110) and/or customer premise equipment (CPE) (120), the system (100) comprising:
a plurality of handheld communication device (110) and/or CPE (120) in communication with a network (130);
a receiving means (140) for receiving user preferences for application deployment thereby causing an application developer to choose an application specific to said user preference;
identifying a plurality of Application Independent Blocks (AIBs) specific to said application chosen;
generating an application flow graph to generate platform independent application code;
selecting platform specific to said handheld device or CPE; and
generating said combinational application by linking said platform independent application code to platform dependent modules corresponding to said selected platform employing an off-line environment, wherein the system enables said application developer to rapidly create combinational applications in said off-line environment for deploying said combinational applications in said handheld communication device and/or CPE independent of underlying networks and platforms of the same.

11. The system (100) as claimed in claim 10, wherein said combinational applications are reusable for creating any of plurality of new applications.

12. The system (100) as claimed in claim 10, wherein said AIBs are service functions for creating combinational applications.

13. The system as claimed in any of claim 10, wherein said AIBs are pre-integrated.

14. The system as claimed in claim 10, wherein said AIBs are capable of encompassing user defined functionalities to enable reuse of said user defined functionalities.

15. The system (100) as claimed in claim 10, wherein said application flow graph defines universal application logic.

16. The system (100) as claimed in claim 10, wherein said method is implemented employing IMS client technology over the existing technologies.

17. The system (100) as claimed in claim 10, wherein said underlying network technologies comprise existing and next generation wireless and wire-line network technologies.
